(19) United States
(12) Patent Application Publication
(10) Pub. No.: US 2023/0349685 A1
(43) Pub. Date: Nov. 2, 2023

(54) Rotation Angle Detecting Device

(71) Applicant: AISAN KOGYO KABUSHIKI KAISHA, Obu-shi, Aichi-ken (JP)

(72) Inventor: Makoto MASE, Handa-shi, Aichi-ken (JP)

(73) Assignee: AISAN KOGYO KABUSHIKI KAISHA, Obu-shi, Aichi-ken (JP)

(21) Appl. No.: 18/025,703

(22) PCT Filed: Sep. 22, 2021
(86) PCT No.: PCT/JP2021/034683

§ 371 Date: Mar. 10, 2023

(30) Foreign Application Priority Data
Oct. 14, 2020 (JP) 2020-172953

(51) Int. Cl. G01B 7/30

(52) U.S. Cl. CPC G01B 7/30

(57) ABSTRACT

A rotation angle detecting device includes a rotating magnet and a sensor configured to detect a rotation angle based on the change in direction of a magnetic flux line generated from the magnet. The magnet includes a first magnetic body and a second magnetic body, which are symmetric about a plane along an axis of rotation. Each of the magnetic bodies has an N pole and an S pole magnetized in the direction of the axis of rotation X. The magnetic poles of rotating surfaces of the magnetic bodies that face the sensor are different. As a result, the length of the magnetic flux line that passes through the sensor is reduced, thereby suppressing a reduction in magnetic field strength and suppressing errors in the angle of the magnetic flux line resulting from an external disturbance magnetic field.

### CROSS-REFERENCE TO RELATED APPLICATIONS

The present application is a 35 U.S.C. § 371 U.S. National Phase entry of, and claims priority to, PCT Application PCT/JP2021/034683 filed Sep. 22, 2021, which claims priority to Japanese Patent Application No. 2020-172953 filed Oct. 14, 2020, each of which is hereby incorporated herein by reference in its entirety for all purposes.

### STATEMENT REGARDING FEDERALLY SPONSORED RESEARCH OR DEVELOPMENT

Not applicable.

### BACKGROUND

The present disclosure relates generally to rotation angle detecting devices.

An engine of a vehicle, such as automobile, includes an intake passage for introducing intake air to the engine. The intake passage is provided with a throttle valve device for controlling the amount of the intake air. The throttle valve device is configured to detect the opening degree of the valve by using a rotation angle detecting device, and to control the amount of the intake air to the engine by changing the opening degree of the valve depending on the step-in amount of an accelerator pedal.

Japanese Laid-Open Patent Publication No. 2020-24102 discloses a conventional rotation angle detecting device. The rotation angle detecting device includes a rotating magnet and a sensor (a magnetism detecting part) facing a rotating front surface of the magnet. The rotation angle detecting device is configured to detect changes in the magnetic field (directions of lines of magnetic flux) caused by rotational of the magnet, so as to detect a rotation angle of a throttle valve. The magnet of the rotation angle detecting device is composed of a single member, and is magnetized such that magnetic poles are directed in radial directions perpendicular to the rotational axis of the magnet. Thus, the N pole and the S pole of the magnet are positioned at a circumferential surface of the magnet. Japanese Laid-Open Patent Publication No. 2020-24102 discloses that a recessed part is formed on the rotating front surface of the magnet.

Due to this, in the rotation angle detecting device, the lines of magnetic flux detected by the sensor are aligned in parallel to each other, in order to precisely detect the rotation angle of the throttle valve.

### SUMMARY

One aspect of this disclosure is a rotation angle detecting device that includes a rotatable magnetic member, and a sensor configured to detect a rotation angle depending on changes in directions of lines of magnetic flux generated from the magnetic member. The magnetic member is configured such that a pair of magnetic bodies symmetrically divided into two about a plane along a rotation axis. The magnetic bodies are magnetized such that N poles and S poles thereof are directed in parallel with the rotational axis. Magnetic poles on rotational front surfaces of the magnetic bodies, which face the sensor, are disposed in such a way as to be mutually different from each other.

Accordingly, there is no ineffective area of the magnetic field at a central part where the magnetic poles switch from each other so that the magnetic field strength at the sensor can be increased in comparison with a conventional magnet where a single magnetic body is magnetized such that magnetic poles thereof are directed in radial direction of the rotation axis. Further, even when a disturbance magnetic field affects the sensor, the detection error can be decreased, thereby precisely detecting the rotational angle.

### BRIEF DESCRIPTION OF DRAWINGS

FIG. 1 is a cross-sectional view of a throttle valve device including a rotation angle detecting device according to a first embodiment.

FIG. 2 is an enlarged cross-sectional view of the rotation angle detecting device of FIG. 1, taken in section II of FIG. 1.

FIG. 3 is a perspective view of a magnetic member of the rotation angle detecting device.

FIG. 4 is a view of the magnetic member of FIG. 3, taken along an arrow IV of FIG. 3.

FIG. 5 is a view of the magnetic member of FIG. 3, taken along an arrow V of FIG. 3.

FIG. 6 is a cross-sectional view of the magnetic member of FIG. 3, take along a line VI-VI of FIG. 3.

FIG. 7 is a cross-sectional view of a magnetic member of a rotation angle detecting device according to a second embodiment, which corresponds to FIG. 6.

FIG. 8 is a cross-sectional view of a magnetic member of a rotation angle detecting device according to a third embodiment, which corresponds to FIG. 6.

FIG. 9 is a schematic view illustrating magnetic paths (lines of magnetic flux) of a magnetic member of a conventional rotation angle detecting device.

FIG. 10 is a schematic view illustrating magnetic paths (lines of magnetic flux) in a case where the rotation angle detecting device of the first embodiment includes a magnetic member not having a recessed part.

FIG. 11 is a schematic view illustrating magnetic paths (lines of magnetic flux) in the rotation angle detecting device of the first embodiment of FIG. 1.

FIG. 12 is a graph showing angle errors in lines of magnetic flux of the magnetic members of FIGS. 9, 10, and 11, which are caused by a disturbance magnetic field.

### DETAILED DESCRIPTION

In the case of the above-described conventional rotation angle detecting device, the magnet is composed of the single member, and the magnetic poles are directed in the radial directions with respect to the rotational direction of the magnet. Thus, the magnetic path in the air becomes longer. This weakens the magnetic field strength applied to the sensor. Accordingly, the device can be easily affected by a disturbance magnetic field during angle detection by the sensor, so that the detection error may increase.

Therefore, there has a need for a rotation angle detecting device capable of suppressing a detection error and accurately detecting a rotation angle even when receiving an influence of a disturbance magnetic field during angle detection by a sensor.

Some embodiments of rotation angle detecting devices disclosed herein will be described below with reference to the drawings. Directions in the following description mean directions of members illustrated in the drawings, respectively, and do not indicate directions of the members in a state where they are mounted on the vehicle, such as automobile, unless clearly specified.

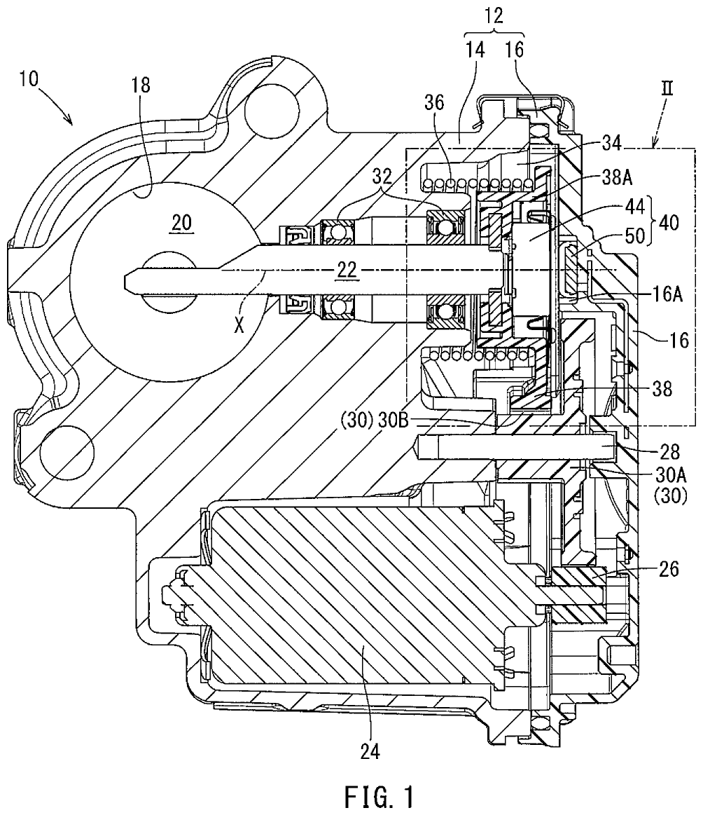

Referring first to FIG. 1, a rotation angle detecting device 40 of a first embodiment is configured to detect the opening degree of a valve 20 of a throttle valve device 10 provided along an intake passage of an engine of a vehicle, such as automobile.

First, the entire configuration of the throttle valve device 10 will be described. FIG. 1 shows a cross-sectional view of the the throttle valve device 10 including the rotation angle detecting device 40. The throttle device 10 is disposed along the intake passage that fluidly connects an intake port of the vehicle to an internal combustion engine. The throttle valve device 10 is configured to open and close the intake passage depending on instruction signals output from an ECU (electronic control unit) of the vehicle, not illustrated, so as to control the amount of the air supplied to the internal combustion engine of the vehicle.

As shown in FIG. 1, the throttle valve 10 includes a valve case body 12 including a case body 14 and a case body cover 16. In FIG. 1, a housing chamber 34 housing the rotation angle detecting device 40 and the like therein is disposed on the right side of the case body 14. The case body cover 16 closes a right end of the housing chamber 34. The case body 14 is made of aluminum alloy. The case body cover 16 is made of resin.

In FIG. 1, a passage 18 defining the intake passage of the vehicle is formed on the left side of the case body 14 of the valve case body 12. The passage 18 extends through the case body 14. The valve 20 is disposed in the passage 18 and has a circular plate shape. The valve 20 is supported on a rotatable, cylindrical valve shaft 22.

The valve shaft 22 extends into an internal space of the case body 14 and protrudes into the housing chamber 34. The case body 14 rotatably supports the valve shaft 22. Thus, the valve 20 is rotatably supported by the case body 14 via the valve shaft 22 and bearings 32, etc. Accordingly, the valve 20 can rotate between a valve closing position for closing the passage 18 and a valve opening position for opening the passage 18 to open and close the passage 18, respectively.

A right end of the valve shaft 22 is connected to a magnetic member 44 of the rotation angle detecting device 40. Thus, the valve 20 is coupled to the magnetic member 44 of the rotation angle detecting device 40 via the valve shaft 22 such that they integrally rotate together in the rotation directions.

The housing chamber 34 of the valve case body 12 houses therein a coil spring 36, a throttle gear 38, an intermediate gear 30, an intermediate shaft 28, a motor gear 26, a motor 24, etc. The motor 24 of this embodiment is a DC motor. The motor gear 26 is made of metal. The intermediate gear 30 and the throttle gear 38 are made of resin.

In FIG. 1, the motor 24 is disposed at a lower position, and is driven depending on instruction signals output from the ECU. The motor 24 is composed of a DC motor, so that the motor 24 is driven by electrically detecting the step-in amount of the accelerator pedal, not shown and by rotating the motor 24 in a stepwise manner in the basis of the step-in amount of the accelerator pedal.

The rotation of the motor 24 is transmitted to the intermediate gear 30 and decelerated via a transmission fitted between the motor gear 26 and a large diameter gear 30A of the intermediate gear 30 that is supported by the intermediate shaft 28. The rotation transmitted to the intermediate gear 30 is further decelerated and is transmitted to the throttle gear 38 via a transmission fitted between a small diameter gear 30B additionally formed on the intermediate gear 30 and the throttle gear 38. The rotation is transmitted to the valve shaft 22 that integrally rotates with the throttle gear 38, so as to open and close the valve 20 within the passage 18.

The coil spring 36 is wound around an outer cylindrical surface of a cylindrical part 38A of the throttle gear 38. The coil spring 36 biases the valve 20 at a position slightly opened from a full-closed position via the throttle gear 38 and the valve shaft 22. Thus, in an initial state where the valve 20 is not rotated by the motor 24, the passage 18 is slightly opened. Further, in the initial state, adjacent turns of the wire of the coil spring 36 are contacted with each other in the axial direction. When the throttle gear 38 is rotated, the coil spring 36 is elastically deformed to decrease its coil diameter. Accordingly, the coil spring 36 biases the valve 20 to the initial position while the rotational positon of the motor 24 is returned.

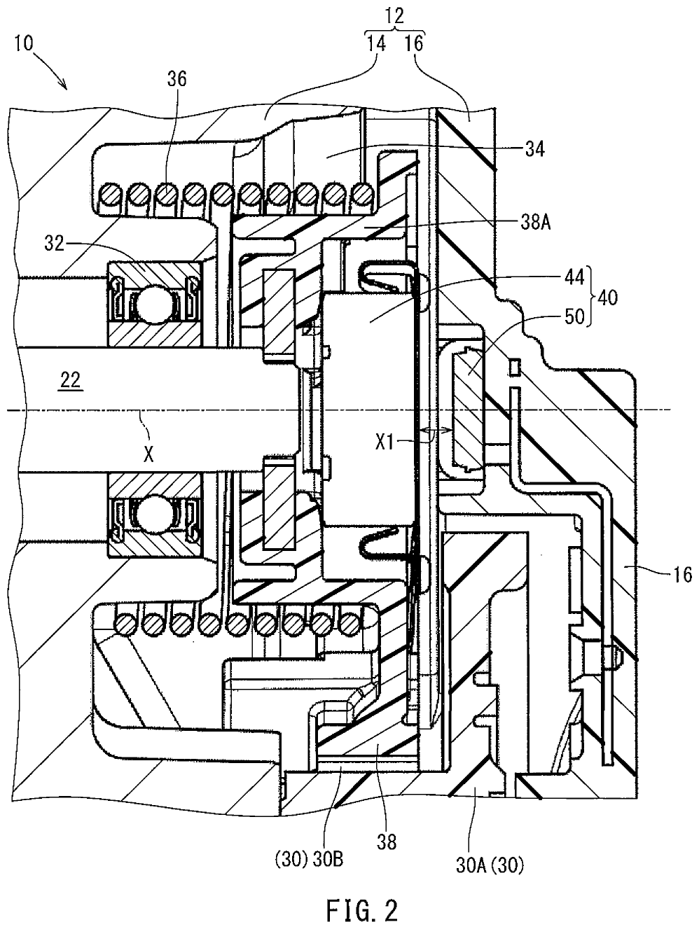

Next, the rotation angle detecting device 40 will be described. FIG. 2 is an enlarged cross-sectional view of a section II of the throttle valve device 10 of FIG. 1, illustrating the rotation angle detecting device 40. The rotation angle detecting device 40 includes the magnetic member 44 and a sensor 50. The rotation angle detecting device 40 is housed in the housing chamber 34 defined by the case body 14 and the case body cover 16. The sensor 50 is disposed and fixed in a concave part 16A of the case body cover 16. The concave part 16A has an inner facing surface that is recessed. In FIG. 2, the magnetic member 44 is connected to the right end of the valve shaft 22 such that the magnetic member 44 and the valve shaft 22 integrally rotate about a rotation axis X. Accordingly, the valve 20 and the magnetic member 44 integrally rotate together in the rotational direction via the valve shaft 22. The magnetic member 44 and the sensor 50 are positioned to face each other with a small gap X1 disposed therebetween in a direction along the rotation axis X of the magnetic member 44.

In this embodiment, the sensor 50 is a magnetic sensor including an electromagnetic conversion IC. The sensor 50 is configured to detect directions of lines of magnetic flux of the magnetic member 44. The directions of lines of magnetic flux detected by the sensor 50 are output to the ECU. The ECU is configured to detect the open state of the valve 20 (see FIG. 1) on the basis of changes in the directions of lines of magnetic flux, which are output from the sensor 50.

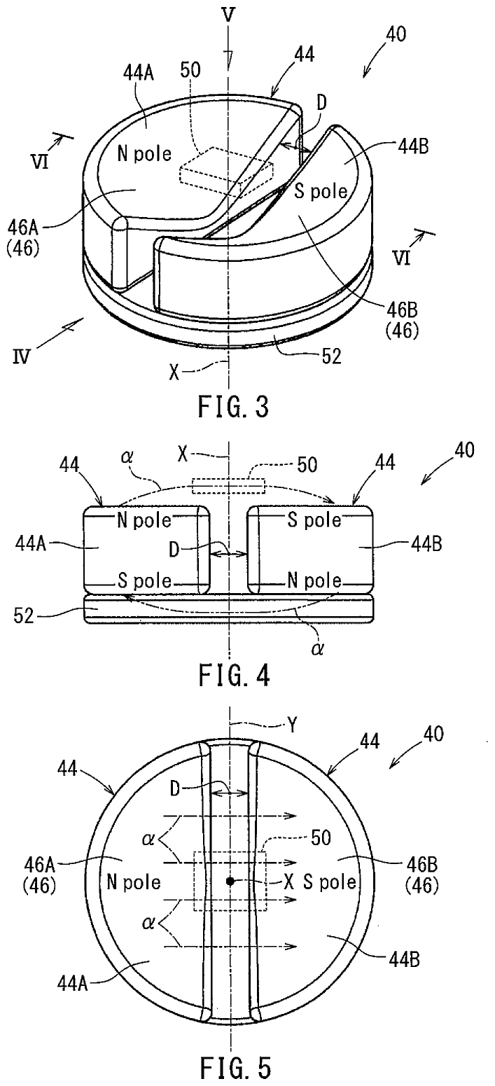

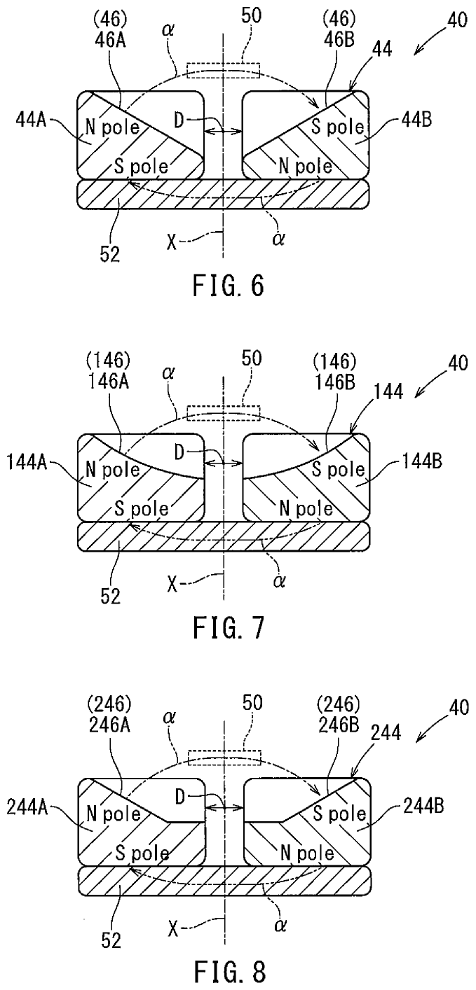

Next, the magnetic member 44 will be described. The magnetic member 44 is composed of permanent magnets. The magnetic member 44 is illustrated in FIGS. 3 to 6. FIG. 3 is a perspective view of the entire configuration of the magnetic member 44. FIG. 4 is a view along the arrow IV of FIG. 3. FIG. 5 is a view along the arrow V of FIG. 3. FIG. 6 is a cross-sectional view along the line VI-VI of FIG. 3. The magnetic member 44 is configured such that a pair of magnetic bodies 44A, 44B, which are symmetrically divided into two along a plane Y extending along the rotation axis X, are arranged as one group (see FIG. 5). One of the pair of the magnetic bodies 44A, 44B is referred to as a first magnetic body 44A, and the other one is referred to as a second magnetic body 44B. In FIGS. 3 to 6, the left one of the magnetic bodies is shown as the first magnetic body 44A, and the right one of the magnetic bodies is shown as the second magnetic body 44B.

FIGS. 3 to 6 clearly show that the first magnetic body 44A and the second magnetic body 44B are symmetrically formed about the plane Y extending along the rotation axis X. The first magnetic body 44A and the second magnetic body 44B are disposed with a small gap D between the facing surfaces thereof. Each of the first magnetic body 44A and the second magnetic body 44B has a semicircular shape in a cross-section perpendicular to the rotation axis X. The first magnetic body 44A and the second magnetic body 44B are arranged relative to each other such that the entire configuration thereof substantially has a circular shape.

Each of the first magnetic body 44A and the second magnetic body 44B has a rotational front surface on the side where the sensor 50 is disposed, and a rotational rear surface on the side opposite to the rotational front surface side. The first magnetic body 44A and the second magnetic body 44B are magnetized such that their N poles and S poles are oriented in directions parallel to the rotational axis X. As shown in FIG. 4, the first magnetic body 44A is magnetized such that the N pole thereof is positioned on the rotational front surface side, and the S pole thereof is positioned on the rotational rear surface side. The second magnetic body 44B is magnetized such that the S pole thereof is positioned on the rotational front surface side, and the N pole thereof is positioned on the rotational rear surface side. Thus, the magnetic poles of the rotational front surfaces of the first magnetic body 44A and the second magnetic body 44B, which face the sensor 50, are arranged to be mutually different in kind (one is an N pole and the other is an S pole). Accordingly, as shown in FIGS. 4 to 6, the lines a of magnetic flux on the rotational front surface side extend from the first magnetic body 44A to the second magnetic body 44B, and the lines a of magnetic flux on the rotational rear surface side extend from the second magnetic body 44B to the first magnetic body 44A.

FIGS. 3 and 6 clearly show that the rotational front surfaces of the pair of the first magnetic body 44A and the second magnetic body 44B define an inclined surface 46 having a concave shape. The inclined surface 46 includes a first inclined surface 46A and a second inclined surface 46B. The first inclined surface 46A is formed on the rotational front surface of the first magnetic body 44A. The second inclined surface 46B is formed on the rotational front surface of the second magnetic body 44B. FIG. 3 clearly shows that the heights of the outer circumferential surfaces of the first inclined surface 46A and the second inclined surface 46B are equal to each other. The first inclined surface 46A and the second inclined surface 46B are formed to be inclined from the outer circumferential surfaces to a center of them in a substantial conical shape. As clearly shown in FIG. 6, each inclined surface 46A, 46B of the first embodiment is formed in an inclined linear shape extending from the outer circumferential surface toward the center in a cross-section along the rotation axis X. The first inclined surface 46A and the second inclined surface 46B are positioned to generally face each other. Accordingly, the lengths of lines of magnetic flux, which pass through the sensor 50 between the first magnetic body 44A and the second magnetic body 44B, are shorter in comparison with a case where the inclined surfaces are not formed.

A yoke 52 made of a magnetic material is disposed on the rotational rear surfaces of the first magnetic body 44A and the second magnetic body 44B that form the magnetic member 44. The yoke 52 is positioned in contact with rear surfaces of the first magnetic body 44A and the second magnetic body 44B such that the yoke 52 is fixably attached and integrated with the first magnetic body 44A and the second magnetic body 44B. Accordingly, as shown in FIGS. 4 and 6, lines a of magnetic flux on the rotational rear surface side of the magnetic member 44 pass through the yoke 52.

Effects of the first embodiment will be described. The rotation angle detecting device 40 detects the opening degree of the valve 20 of the throttle valve device 10 shown in FIG. 1. As shown in FIGS. 1 and 2, the valve 20 and the magnetic member 44 of the rotation angle detecting device 40 are integrated with each other with respect to the rotational direction such that the valve 20 and the magnetic member 44 integrally rotate. The sensor 50 detects changes in the magnetic field, in other words, changes in directions of lines a of magnetic flux, caused by rotation of the magnetic member 44, and then the opening degree of the valve 20 is calculated.

As shown in FIGS. 3 to 6, the magnetic member 44 of the rotation angle detecting device 40 of the first embodiment is configured such that the first magnetic body 44A and the second magnetic body 44B are arranged as one pair. Each of the magnetic bodies 44A, 44B is magnetized such that the N pole and the S pole thereof are directed in directions parallel to the rotational axis X. The magnetic poles of the rotational front surfaces of the magnetic bodies 44A, 44B are mutually different in kind. This can shorten the lengths of the lines a of magnetic flux passing through the sensor 50 in comparison with a conventional case where a magnetic member is magnetized to have magnetic poles directed in the radial directions. Further, there is no ineffective area of the magnetic field at a central part where the magnetic poles switch from each other, so that a decrease in the magnetic field strength passing through the sensor 50 can be suppressed. Accordingly, even when a disturbance magnetic field affects the sensor 50, the detection error can be decreased, thereby precisely detecting the rotational angle.

In the magnetic member 44 of the first embodiment, the rotational surfaces of the first magnetic body 44A and the second magnetic body 44B on the side, in which the sensor 50 is disposed, are formed to be inclined to have a concave shape. In a case where the rotational surfaces on the side where the sensor 50 is disposed are formed to be inclined to have the concave shape in this manner, it is possible to make the lengths of the lines of magnetic flux passing through the sensor 50 much shorter. Thus, the decrease in the magnetic field strength can be suppressed much more, thereby precisely detecting the rotational angle.

The magnetic member 44 of the first embodiment is disposed such that the rotational rear surface thereof is in contact with the yoke 52. The yoke 52 is made of a magnetic material, such as iron. Due to this configuration, the magnetic flux extends from the rotational rear surface of the magnetic member 44 passes through the yoke 52. This can suppress the decrease in the magnetic field strength. It is possible to suppress the decrease in the magnetic field strength on the sensor side 50 where the magnetic field extends in the air, so that the detection error can be decreased much more even when the sensor 50 is affected by the disturbance magnetic field. Accordingly, this configuration can also improve the accuracy of the rotational angle detection.

The first magnetic body 44A and the second magnetic body 44B of the magnetic member 44 of the first embodiment are disposed with a gap therebetween. Due to this configuration, there is no ineffective area of the magnetic field caused by the magnetic domain wall. Accordingly, magnetic energy per volume can be used effectively, thereby improving the accuracy of the rotational angle detection much more.

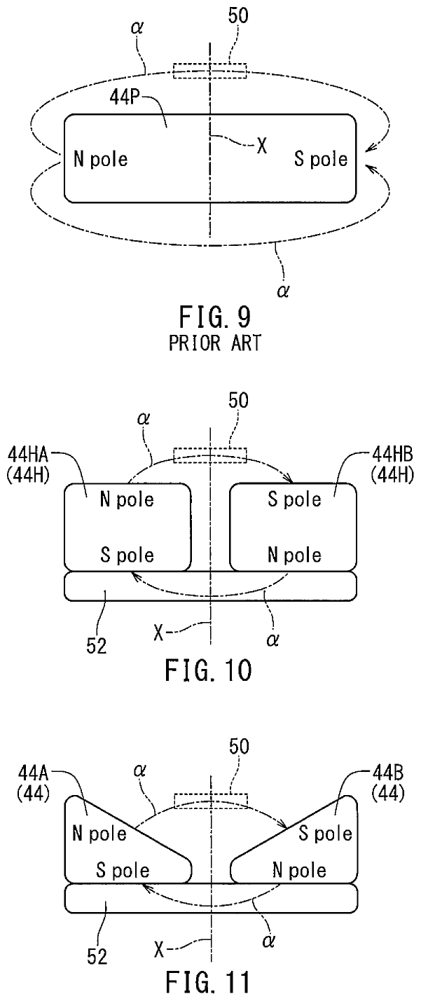

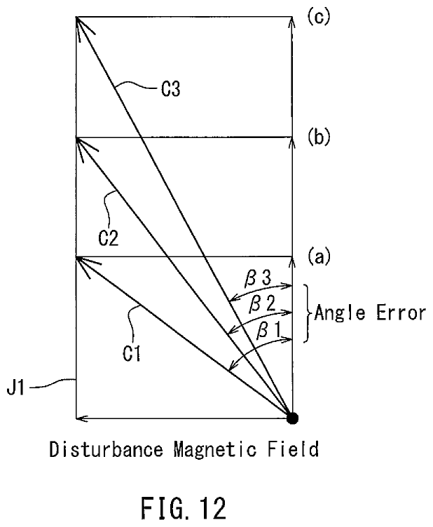

FIGS. 9 to 12 show differences between the conventional rotation angle detecting device and rotation angle detecting devices of this disclosure. FIG. 9 is a schematic view illustrating the magnetic path (lines of magnetic flux) of the magnetic member in the conventional angle detecting device. FIG. 10 is a schematic view showing the magnetic path (lines of magnetic flux) in a state where the magnetic member that does not have a concave shape is used for the rotation angle detecting device of the first embodiment. FIG. 11 is a schematic view illustrating the magnetic path (lines of magnetic flux) of the magnetic member of the rotation angle detecting device of the first embodiment. FIG. 12 is a diagram showing angle errors in lines of magnetic flux of the magnetic members of FIGS. 9 to 11, wherein the angle errors are caused by the disturbance magnetic field.

The configuration (a) in FIG. 9 will be described. FIG. 9 shows the arrangement of a conventional magnetic member 44P and the sensor 50. The conventional magnetic member 44P is composed of a single member having a circular cross-section. The conventional magnetic member 44P is magnetized such that the N pole and the S pole thereof are directed in the radial directions. Thus, lines of magnetic flux of the magnetic member 44P extend from the N pole to the S pole on the outer circumferential surface in the circular cross-section. The lines a of magnetic flux passing through the sensor 50 extend over the entire length of the magnetic member 44P, and thus, are relatively long. Accordingly, the magnetic field strength of the lines a of magnetic flux passing through the sensor 50 is weak.

The configuration (b) in FIG. 10 will be described. FIG. 10 shows the configuration where the rotational front surface of the magnetic member 44 of the first embodiment does not have a concave-shaped inclined surface. The magnetic member 44H of FIG. 10 is disposed such that the first magnetic body 44HA and the second magnetic body 44HB that are formed by being divided into two, are arranged as one pair, like the magnetic member 44. The yoke 52 made of the magnetic material is disposed on the rotational rear surface side of the magnetic member 44H, like the first embodiment.

The first magnetic body 44HA and the second magnetic body 44HB are magnetized such that magnetic poles are directed in the directions parallel to the rotational axis X, and such that the magnetic poles of them on the rotational front surface side are mutually different in kind. In the case of the magnetic member 44H of FIG. 10, the magnetic pole of the rotational front surface of the first magnetic body 44HA is N pole, and the magnetic pole of the rotational front surface of the second magnetic body 44HB is S pole.

As described above, the basic arrangement of the magnetic member 44H of FIG. 10 is similar to that of the first embodiment. Thus, the lines a of magnetic flux extend from the rotational front surface of the first magnetic body 44HA to the rotational front surface of the second magnetic body 44HB, so that the lengths of the lines a of magnetic flux are shorter than the lengths of the lines of magnetic flux of the conventional magnetic member 44P of FIG. 9. Accordingly, the magnetic field strength of the lines a of magnetic flux passing through the sensor 50 is strong in comparison with the case of the conventional magnetic member 44P of FIG. 9.

The configuration (c) shown in FIG. 11 will be described. FIG. 11 corresponds to the first embodiment. The magnetic member 44 corresponds one shown in FIG. 6. The lines of magnetic flux extend from the inclined surface 46A of the first magnetic body 44A to the inclined surface of the second magnetic body 44B, so that the lengths thereof are short in comparison with the case of the magnetic member 44H of FIG. 10. Accordingly, the magnetic field strength passing through the sensor 50 becomes stronger.

FIG. 12 will be described with reference to FIGS. 9 to 11. FIG. 12 is a diagram showing differences between angle errors in lines of magnetic flux affected by a disturbance magnetic field. The differences are caused by the configurations of the magnetic members 44, 44H, and 44P, shown in FIGS. 9 to 11. The vertical axis of FIG. 12 corresponds to the magnetic field strength of the lines a of magnetic flux generated by each of the magnetic members 44, 44H, and 44P of FIGS. 9 to 11 when passing through the sensors 50. Thus, it is shown that the conventional configuration (a) of the magnetic member 44P is the lowest, the configuration (b) of the magnetic member 44H is middle, and the configuration (c) of the magnetic member 44 is the highest.

The horizontal axis of FIG. 12 corresponds to the strength of the disturbance magnetic field J. The horizontal axis in the horizontal axis means that the disturbance magnetic field becomes stronger to the left. FIG. 12 illustrates a state where the disturbance magnetic field is J1.

In FIG. 12, the angle variation line C1 of the lines of magnetic flux corresponds to the conventional configuration of the magnetic member 44P of FIG. 9, which is affected by the disturbance magnetic field J1, and the angle error with respect to the normal condition is indicated by β1. The angle variation line C2 of the lines of magnetic flux corresponds to the configuration (b) of the magnetic member 44H of FIG. 10, and the angle error with respect to the normal condition is indicated by (32. The angle variation line C3 of the lines of magnetic flux corresponds to the configuration (c) of the magnetic member 44 of FIG. 11, and the angle error with respect to the normal condition is indicated by β3.

FIG. 12 shows that the relationship between the angle errors caused by the disturbance magnetic field is β1>β2>β3. It is shown that the angle errors caused by the disturbance magnetic field become smaller in the order of the magnetic member 44P of FIG. 9, the magnetic member 44H of FIG. 10, and the magnetic member 44 of FIG. 11. In other words, the magnetic members 44 and 44H can suppress the detection error and improve the accuracy of the rotational angle detection in comparison with the conventional configuration even when it is affected by the disturbance magnetic field during angle detection by the sensor 50 of the rotation angle detecting device 40. In the case of the magnetic member 44 having the concave-shaped inclined surface 46 at the rotational front surface, shown in FIG. 11, it is possible to minimize the detection error, thereby precisely detecting the rotational angle.

A second embodiment will be described. FIG. 7 is a cross-sectional view of a magnetic member 144 of the second embodiment, which corresponds to FIG. 6 illustrating the first embodiment. The basic configurations of this embodiment are same as those of the first embodiment, and an inclined surface 146 of the magnetic member 144 is only changed. Accordingly, the different features will be described, whereas the same features are labelled with the same reference numerals and the descriptions thereof will not be repeated.

The magnetic member 144 of FIG. 7 has the inclined surface 146 having a concave curved shape, instead of the inclined surface 46 of the first embodiment shown in FIG. 6. In a case where the inclined surface 146 is curved, it is possible to obtain the same effects as those of the first embodiment.

A third embodiment will be described. FIG. 8 is a cross-sectional view of a magnetic member 244 of the third embodiment, which corresponds to FIG. 6 illustrating the first embodiment. The basic configurations of this embodiment are same as those of the first embodiment, and an inclined surface 246 of the magnetic member 244 is only changed. Accordingly, the different features will be described, whereas the same features are labelled with the same reference numerals and the descriptions thereof will not be repeated.

In FIG. 8, the magnetic member 244 includes an inclined surface 246 having a concave bent-line shape composed of two linear lines. In a case where the inclined surface 246 has such bent-line shape composed of two liner lines, it is possible to obtain the same effects as those of the first embodiment.

The embodiments described above are representative examples of the present disclosure and do not limit the scope of this disclosure, and they can be variously modified without departing from the gist of the disclosure. The additional features described above can be applied separately or can be combined with other features.

For example, the rotation angle detecting device 40 is used for the throttle valve device 10 provided along the intake passage of the engine of the vehicle, such as automobile. This disclosure can be widely applied to other devices configured to detect a rotational axis.

The first magnetic body 44A and the second magnetic body 44B, which are formed by dividing the magnetic member 44 of the rotation angle detecting device 40 into two, are disposed with the gap D. The first magnetic body 44A and the second magnetic body 44B may be disposed with no gap therebetween to be in contact with each other.

Although the rotational front surface of the magnetic member 44 has the inclined surface 46 having the concave shape on the side where the sensor 50 is disposed, it does not necessarily have such concave shape. In other words, the rotational front surface of the magnetic member 44 may have a planar shape on the side where the sensor 50 is disposed.

The yoke 52 composed of the magnetic material is disposed on the rotational rear surface of the magnetic member 44 on the side opposite to the rotational front surface that faces the sensor 50. When a predetermined magnetic field strength is provided without the yoke 52, the yoke 52 may be omitted.

The entire shape of the magnetic member 44 is a circular shape, but may be a polygonal shape.

Various aspects of the subject matter are disclosed herein. The first aspect is a rotation angle detecting device that includes a rotatable magnetic member, and a sensor configured to detect a rotation angle depending on changes in a direction of a magnetic flux line generated from the magnetic member. The magnetic member is configured such that a pair of magnetic bodies that are formed by symmetrically divided into two about a plane along a rotation axis are disposed one group. The magnetic bodies are magnetized such that N poles and S poles thereof are directed in parallel with the rotational axis. Magnetic poles of on rotational font surfaces of the magnetic bodies, which face the sensor, are disposed in such a way as to be mutually different from each other.

In accordance with the first aspect, the magnetic member is configured such that a pair of the magnetic bodies that are symmetrically divided into two are disposed as one group. The magnetic bodies are magnetized such that N poles and S poles thereof are directed in directions parallel to the rotational axis. Magnetic poles of on rotational front surfaces of the magnetic bodies, which face the sensor, are disposed in such a way as to be mutually different from each other. Accordingly, there is no ineffective area of the magnetic field at a central part where the magnetic poles switch from each other, so that the magnetic field strength at the sensor can be increased in comparison with a conventional magnet where a single magnetic body is magnetized such that magnetic poles thereof are directed in radial directions of the rotation axis. Further, even when the sensor is affected by the disturbance magnetic field, the detection error can be decreased, thereby precisely detecting the rotational angle.

The second aspect is the rotation angle detecting device of the first aspect, wherein the magnetic bodies are disposed with a gap therebetween.

In accordance with the second aspect, the magnetic bodies are disposed with a gap therebetween. Accordingly, there is no ineffective area of the magnetic field caused by the magnetic domain wall, so that magnetic energy per volume can be effectively used.

The third aspect is the rotation angle detecting device of the first or second aspect, wherein a yoke made of a magnetic material is disposed on a rotational rear surface of the magnetic member on a side opposite to the rotational front surface side that faces the sensor.

In accordance with the third aspect, the yoke is disposed on the rotational rear surface of the magnetic member on the side opposite to the rotational front surface side that faces the sensor. The lines of magnetic flux extend through the yoke on the rotational rear surface side. Because the lines of magnetic flux extend through the yoke on the rotational rear surface side, it is possible to decrease the strength of the lines of magnetic flux passing through the air on the rotational front surface side, thereby suppressing a decrease in the magnetic field strength. Accordingly, the decrease of the strength of the magnetic field passing through the air on the sensor side can be suppressed. Thus, even when the sensor is affected by the disturbance magnetic field, the detection error can be decreased, thereby improving the accuracy of the rotational angle detection much more.

The fourth aspect is the rotation angle detecting device of the any one of the first to third aspects, wherein the rotational front surface of each magnetic body is formed as an inclined surface shape that has a concave shape

In accordance with the fourth aspect, it is able to make the length of the magnetic flux line extending through the air short by forming the rotational front surface of the magnetic member as the inclined surface shape. Thus, the decrease in the magnetic field strength at the sensor can be suppressed much more, thereby precisely detecting the rotational angle.

1. A rotation angle detecting device, comprising:
a magnetic member configured to rotate about a rotation axis; and
a sensor configured to detect a direction of a magnetic flux line generated by the magnetic member, wherein:
the magnetic member includes a first magnetic body and a second magnetic body that are symmetric about a lane along the rotation axis;
each of the first magnetic body and the second magnetic body includes an N pole and an S pole that are directed in an axial direction;
the first magnetic body has the N pole on a rotational front surface of the first magnetic body;
the second magnetic body has the S pole on a rotational front surface of the second magnetic body; and
the rotational front surface of the first magnetic body and the rotational front surface of the second magnetic body face the sensor.

2. The rotation angle detecting device of claim 1, wherein a gap is disposed between the first magnetic body and the second magnetic body.

3. The rotation angle detecting device of claim 1, wherein:
the first magnetic body has a rotational rear surface opposite to the rotational front surface of the first magnetic body;
the second magnetic body has a rotational rear surface opposite to the rotational front surface of the second magnetic body; and
a yoke made of a magnetic material is disposed on both the rotational rear surface of the first magnetic body and the rotational rear surface of the second magnetic body.

4. The rotation angle detecting device of claim 1, wherein:
the rotational front surface of the first magnetic body and the rotational front surface of the second magnetic body are inclined with respect to the rotation axis such that the rotational front surface of the first magnetic body and the rotational front surface of the second magnetic body form a concave shape.
